(19) United States
(12) Patent Application Publication
(10) Pub. No.: US 2025/0378100 A1
(43) Pub. Date: Dec. 11, 2025

(54) LARGE LANGUAGE MODEL ENCODING OF GRAPH NEURAL NETWORK EDGE TEXTUAL INFORMATION

(71) Applicant: PAYPAL, INC., San Jose, CA (US)

(72) Inventor: Ori Mendelson, Tel-Aviv (IL)

(21) Appl. No.: 18/738,631

(22) Filed: Jun. 10, 2024

(51) Int. Cl. G06F 16/34; G06F 40/20

(52) U.S. Cl. CPC G06F 16/34; G06F 40/20

(57) ABSTRACT

A method includes accessing a large language model (LLM) configured to encode textual information to generate encoded textual information, receiving a data set having a plurality of entities and a plurality of relationships among the entities, each relationship associated with respective textual information, determining a graph representative of the data set, the graph comprising a plurality of nodes and a plurality of edges connecting the nodes, each node representative of a respective entity of the plurality of entities and each edge representative of the relationship between the entities connected by the edge, wherein the determining includes, for each edge, applying the LLM to the associated textual information to generate encoded edge textual information and adding the encoded edge textual information to the edge in the graph, whereby an enhanced graph is generated, and training a graph neural network model (GNN) based on the enhanced graph.

### TECHNICAL FIELD

This disclosure relates to the use of graph neural networks and other machine learning models, including the enhancement of graph neural networks according to the output of another model or models.

### BACKGROUND

Many real-world problems can be modeled by graphs, which in turn can be the basis for a graph neural network to solve the real-world problem. The graph can include nodes representative of entities as well as edges representative of relationships between entities. Both nodes and edges can include associated numeric and/or textual information.

### BRIEF DESCRIPTION OF THE DRAWINGS

FIG. 1 is a block diagram view of an example system for training and deploying an enhanced graph neural network for problem solving.

FIG. 2 is a block diagram view of an example system and method for training and deploying a set of machine learning models for problem solving.

FIG. 3 is a diagram illustrating enhancement of a graph using a large language model applied to edge textual information of the graph.

FIG. 4 is a flow chart illustrating an example method of enhancing a graph to improve predictions by a graph neural network.

FIG. 5 is a flow chart illustrating an example method of ieratively training multiple machine learning models to improve predictions by a graph neural network.

FIG. 6 is a block diagram of an example computing system.

### DETAILED DESCRIPTION

Many computing applications can benefit from the application of a graph neural network to make predictions or classifications respective of the entities represented in the graph, or of relationships between those entities. Such a graph may include, for example, a graph of inter-party transactions, in which each node represents a party and each edge represents a transaction; an interactions graph in which each node represents a party, item (e.g., computing system or other hardware), or service (e.g., computing service), and each edge represents an interaction between those parties, items, or services; or a dispute graph in which each node represents a party or a computing action, and each edge represents a dispute respective of the party/action combination (e.g., a request to cancel the action). Classifying and/or quantifying the risk of a computing action involving one or more entities in such graphs may involve applying a graph neural network to the graph.

Each graph type may include numeric and/or textual information along its edges and at its nodes. Node textual information may include, for example, text that describes a party, item, service, or action. Edge textual information may include, for example, text that describes a transaction, other inter-entity interaction, or dispute. Such text may be generated by a user or other entity in the course of the relationship represented by the graph, or may be predefined for the relationship.

A graph neural network generally cannot process textual information associated with edges. Textual information, however, may provide important context or detail on a relationship that could improve the accuracy of a graph neural network if it is presented to the graph neural network in a processable form. Accordingly, the present disclosure improves the accuracy and deployment scope of a graph neural network by incorporating edge textual information into a graph in a form usable by a graph neural network.

In some embodiments, the instant disclosure enables enhancement of a graph for use by a graph neural network by applying a large language model or other machine learning model to each piece of edge text to generate an embeddings vector representative of that piece of edge text, and adding the edge text embeddings vector to the graph. Because the embeddings vector is digestable by a graph neural network, the graph neural network can incorporate the edge textual information for its classifications and predictions, thereby improving the accuracy of the graph neural network.

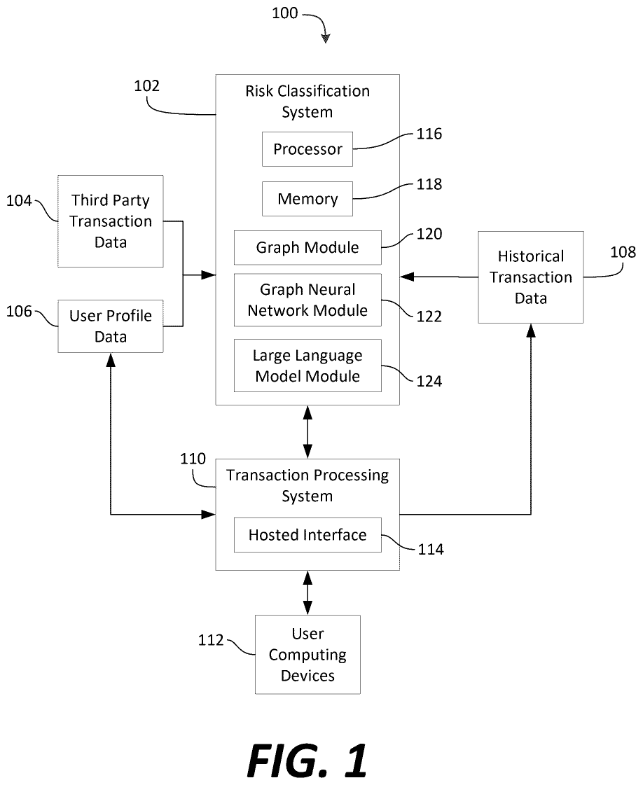

Turning to the figures, in which like numerals refer to the same or similar features in the various views, FIG. 1 is a block diagram view of an example system 100 for training and deploying a machine learning model for use in risk classification and prediction. The system 100 may include a risk classification system 102, a source of third party transaction data 104, a source of user profile data 106, a source of historical transaction data 108, and a transaction processing system 110 that may communicate with one or more (e.g., a plurality of) user computing devices 112.

The transaction processing system 110 may be associated with (e.g., may host) a particular electronic user interface 114 and/or platform through which users (which may include individual end users, enterprise users such as merchants, etc.) perform electronic transactions (e.g., any of enterprise-to-end user transactions, end user-to-end user transactions, and enterprise-to-enterprise transactions). The electronic user interface 114 may be embodied in a website, mobile application, etc. According, the transaction processing system 110 may be associated with or wholly or partially embodied in one or more servers, which server(s) may host the interface 114, and through which the user computing devices 112 may access the user interface.

The historical transaction data 108 may include records of a plurality of previous transactions (or other computing actions) performed through the transaction processing system 110. The records may include, for each transaction, one or more parties involved in the transaction (e.g., end users, enterprise users, etc.) and one or more numeric and/or textual characteristics of the transaction. The characteristics of the transaction may include, for example, dates, values, a subject of the transaction (e.g., asset accessed or exchanged), party comments to the transaction, messages exchanged between the parties in the course of the transaction, and so on. A given party may have one or more associated transactions stored in the historical transaction data 108.

The third party transaction data 104 may, like the historical transaction data 108, include records of a plurality of transactions, including one or more parties involved in the transaction and one or more characteristics of the transaction. The third-party transaction data 104 may include, however, transactions performed other than through the transaction processing system 110 (e.g., transactions that were not processed by the transaction processing system 110). The third-party transaction data 104 may include, for example, credit bureau data or data from another third party source that tracks transactions or other computing actions by various users and other parties.

The user profile data 106 may include user profiles for a plurality of users of the transaction processing system 110. A user profile may include, for example, a user's bibliographic information, location information, transaction history, and the like.

The risk classification system 102 may include a processor 116 and a non-transitory, computer-readable medium (e.g., memory) 118 storing instructions that, when executed by the processor 116, cause the risk classification system 102 to perform one or more processes, operations, methods, algorithms, etc. of this disclosure. The risk classification system 102 may include one or more functional modules 120, 122, 124. Specifically, the risk classification system 102 may include a graph module 120, a graph neural network (GNN) module 122, and a large language model (LLM) module 124. Each module 120, 122, 124 may be embodied in hardware and/or software (e.g., as instructions in the memory 118). In general, the risk classification system 102 may classify or predict a risk of a desired computing action by a user, and/or make other classifications or predictions.

The graph module 120 may receive data respective of entities and relationships between those entities and construct and store a graph representative of the entities and relationships. For example, in some embodiments, the graph module 120 may receive data from the historical transaction data 108, the third party transaction data 104, and/or the user profile data 106 and construct and store an inter-party transactions graph, an interactions graph, a dispute graph, etc.

The graph module 120 may also revise a stored graph with encoded edge textual information and/or encoded node textual information. Alternatively, the graph module 120 may incorporate such encoded textual information into a new graph as it is built. Such encoded text information may be received from an encoding machine learning model, such as the LLM module 124 described below.

The GNN module 122 may store a graph neural network model, receive a graph as input, apply the graph neural network model to the graph, and output one or more predictions and/or classifications made by the GNN model regarding the input graph (e.g., regarding one or more nodes or edges), and/or one or more embeddings vectors respective of one or more entities or relationships represented in the graph, where those output embeddings vectors may be processed by other models. The GNN module 122 may further train the GNN model based on one or more training data sets. For example, the GNN module may train the GNN model based on data from the historical transaction data 108, the third party transaction data 104, and/or the user profile data 106.

The LLM module 124 may store a large language model, receive text as input, apply the LLM to the received text, and output one or more encoded text representations (e.g., text embeddings vectors). For example, the LLM module 124 may receive edge text and/or node text from a graph and output an embeddings vector representative of each item of text. The LLM module 124 may further train the LLM based on one or more training data sets. For example, the LLM module 124 may train the LLM according to edge text and/or node text from a graph along with predictions respective of that graph made by the GNN model.

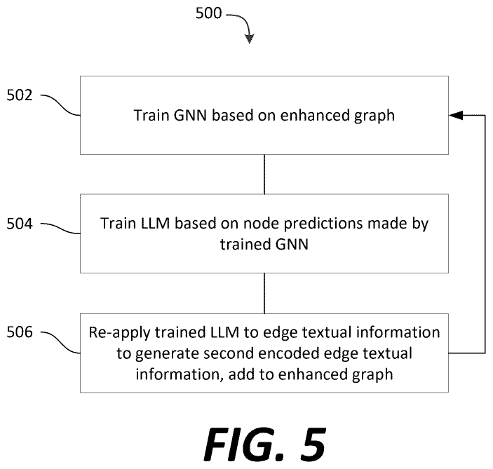

In some embodiments, the GNN module 122 and the LLM module 124 may iteratively train the GNN model and the LLM in conjunction. For example, predictions from the GNN model may be used to fine-tune the LLM, and embeddings generated by the LLM may be used to fine-tune the GNN, and the predictions made by the fine-tuned GNN may be used to further fine-tune the LLM, and so on. An example co-training process will be described below in connection with FIG. 5.

The risk classification system 102 may find use in a wide variety of contexts. As noted above, many such contexts may include assessing a risk of enabling a user to perform a certain computing action. For example, the risk classification system 102 may be used to classify or quantify a risk (e.g., by determining a probability that a negative event will occur) associated with an input user and an input transaction or other computing action. The predictions may be used in risk-related decisions and/or other decisions related to granting users permission to engage in computing actions, including but not limited to credit applications, fraud detection, site access, shared resource access, etc.

In some embodiments, the risk classification system 102 (e.g., the functionality thereof) may be deployed in order to determine whether or not to extend credit to users. In such embodiments, a user's requested computing action may be the request for credit (e.g., a request to perform a certain transaction on credit). In such embodiments, the risk classification system 102 may receive information about the user (e.g., where the user may be represented by one or more nodes in the graph) and the requested amount of credit (which also may be associated with the one or more user nodes, and/or with an edge in the graph) and output a risk associated with extending the credit to the user. The risk may represent, for example, a risk that the user will default on the credit, a risk that the user will perform a fraudulent transaction using the credit, etc. The transaction processing system 110 may utilize such output to grant or deny the request for credit.

In other embodiments, the risk classification system 102 may be deployed in order to determine whether or not to grant access to a common computing service to users. In such embodiments, a user's requested computing action may be a request to use a certain volume of computing resources, or a request to perform a certain series of computations using the common computing service. In such an embodiment, the risk classification system 102 may receive information about the user (e.g., embedded in the graph as information associated with one or more user nodes) and the requested quantity or type of computing resources (e.g., embedded in the graph as one or more edges) and output a risk associated with permitting the user access to the requested computing resources. The risk may represent, for example, a risk that the user may perform unauthorized operations with the shared computing resources (e.g., illegal activity), a risk that the user may upload malicious code to the shared computing resources, a risk that the user may conduct fraudulent operations with the shared computing resources, or some other risk. The risk processing system may utilize such output to grant or deny the request for the user to use the common computing service.

In other embodiments, the risk classification system 102 may be deployed in order to determine whether or not to grant access to a physical site (e.g., a facility, specific computing hardware, etc.) to users. In such embodiments, a user's requested computing action may be a request to access the site (e.g., presentation of a credential by the user at a secure access scanner), or to be authorized to access the site. In such an embodiment, the risk classification system 102 may receive information about the user (e.g., embedded in the graph as one or more user nodes) and the site (e.g., also embedded in the graph as one or more nodes, with associated node information such as numeric value of hardware at the site, or numeric downside value of potential illicit activity at the site) and output a risk associated with permitting the user access to the requested site. The risk may represent, for example, a risk of theft associated with the user, a risk that the user will damage the site or some portion of the site, or some other risk. The risk evaluation system 102 may utilize such output to grant or deny the request for the user to access the site.

In addition to risk classification, the functionality of the graph module 120, the GNN module 122, and the LLM module 124 may be utilized to make predictions in a wide variety of contexts. For example, the GNN model may be used to model or label non-user systems, to model or label user systems for characteristics other than risk, to classify an entire system represented by a graph, and so on. For example, the GNN model may be used to classify the likelihood of each of a plurality of parties to engage in a particular behavior, to classify one or more users or items as trusted, and so on.

In other embodiments, the GNN may be used for predictions and classifications other than risk assessment. For example, the GNN may be used to predict a next action by a user (e.g., where that user is represented by one or more nodes in the graph), such that the predicted next action can then be recommended to the user, auto-filled, etc. In another example, the GNN may be used to classify strengths or characteristics of relationships between entities in a social media or other user graph, and the strengths or characteristics may be used for, e.g., content presentation and selection.

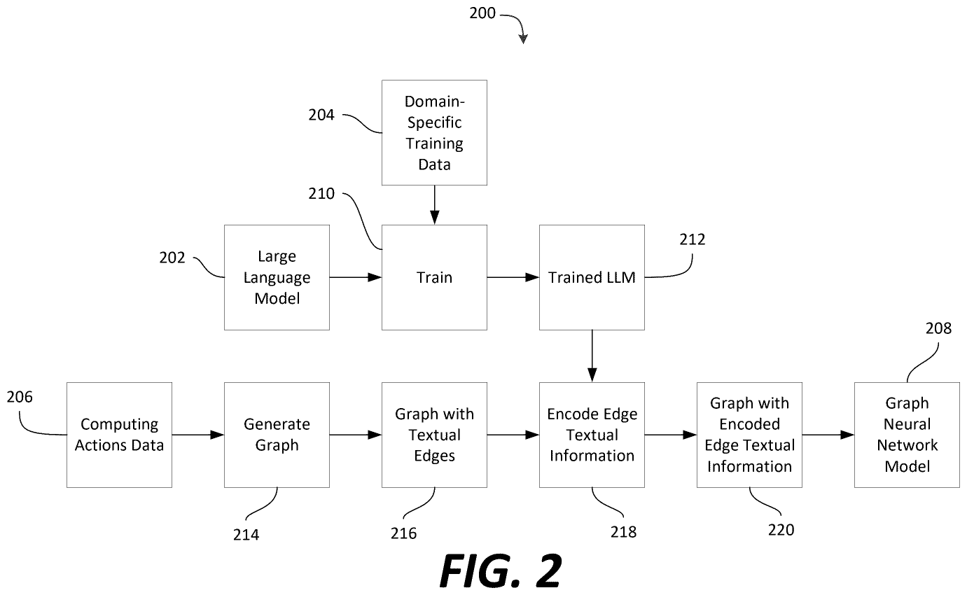

FIG. 2 is a block diagram view of an example system and method 200 for training and deploying a set of machine learning models for problem solving. The system includes an LLM 202, a corpus of domain specific training data 204, a set of computing actions data 206, and a GNN model 208.

At block 210, the method 200 includes training the LLM 202 according to the domain-specific training data 204. The LLM 202 may be trained to output an embeddings vector representative of input text. In some embodiments, the domain-specific training data 204 may be specific to a domain in which the GNN model 208 will be deployed. For example, the domain-specific training data 204 may be, may include, or may be a subset of the computing actions data 206 that, as described below, may be used to build a graph. The training data 204 may include text that would be included in a graph respective of the domain, such as text descriptive of one or more entities such as parties, items, services, etc. that could be associated with a node in such a graph, and/or text descriptive of one or more transactions, events, disputes, or other relationships between such entities that may be associated with an edge in such a graph. Where the LLM 202 outputs an embeddings vector representative of the text, training the LLM may include comparing the embeddings vectors generated by the LLM to known groupings, classifications, associations, etc. of the training data text and minimizing a loss function respective of the differences between the embeddings vectors and the known groupings, classifications, associations, etc. The result of training at block 210 is a domain-specific trained LLM 212.

At block 214, the method 200 includes generating a graph with textual edges 216 based on the computing actions data 206. The computing actions data 206 may include, for example, the third party transaction data 104, the historical transaction data 108, and/or the user profile data 106 of FIG. 1. More generally, the computing actions data 206 may include computing actions respective of a domain in which the GNN model 208 will be deployed, and entities involved in those actions, such as by performing the action or receiving a result of the action. For example, where the GNN model 208 will be deployed to characterize sub-portions of a social network, the computing actions data 206 may include users and interactions on that social network. In another example, where the GNN model 208 will be deployed to characterize a physical system or aspects of the large computing system (e.g., a data center), the computing actions data 206 may include the subsystems and connections between the subsystems within the large computing system. The resulting graph with textual edges 216 may be an inter-party transactions graph, an interactions graph, a dispute graph, etc.

The graph with textual edges 216 may include edges such that repeated interactions between nodes can be temporally reconstructed. For example, the graph may include a separate edge for each interaction, such that two nodes with five interactions between them will have five edges connecting those two nodes, in some embodiments.

One or more nodes, and one or more edges, in the graph 216 may have associated text. As discussed above, edge text may include text that describes the particular interaction or other relationship represented by the edge, such as a user review or a user-to-user note associated with an inter-party transaction, a user submission associated with a dispute, a description of resources conveyed from an enterprise user to an end user, a user comment associated with a user-item or user-service interaction, a developer note associated with a system-to-system connection, and so on. In embodiments, the edge text may include user-generated edge text, which may not be easily reduceable to numeric form. The text associated with the nodes and/or edges may be in addition to numerical attributes and data also associated with the nodes and edges.

At block 218, the method 200 may include applying the trained LLM 212 to the edge text of the graph 216 to encode the edge text information of the graph 216 to determine an enhanced graph. Block 218 may include generating a respective embeddings vector by the LLM 212 for each edge in the graph 216, representative of the respective text of that edge. The result of block 218 may be a graph with encoded edge textual information 220, also referred to herein as an enhanced graph 220.

The GNN model 208 may be applied to the enhanced graph 220 to make one or more classifications, predictions, etc. respective of the entities, relationships, etc. represented in the graph 220. Because the edge textual information is embodied as embeddings vectors in the enhanced graph 220, the edge textual information may be accounted for and may influence the predictions and classifications made by the GNN model 208. In some embodiments, the GNN model may output one or more embeddings vectors respective of the enhanced graph 220, which embeddings vectors may be used by further models.

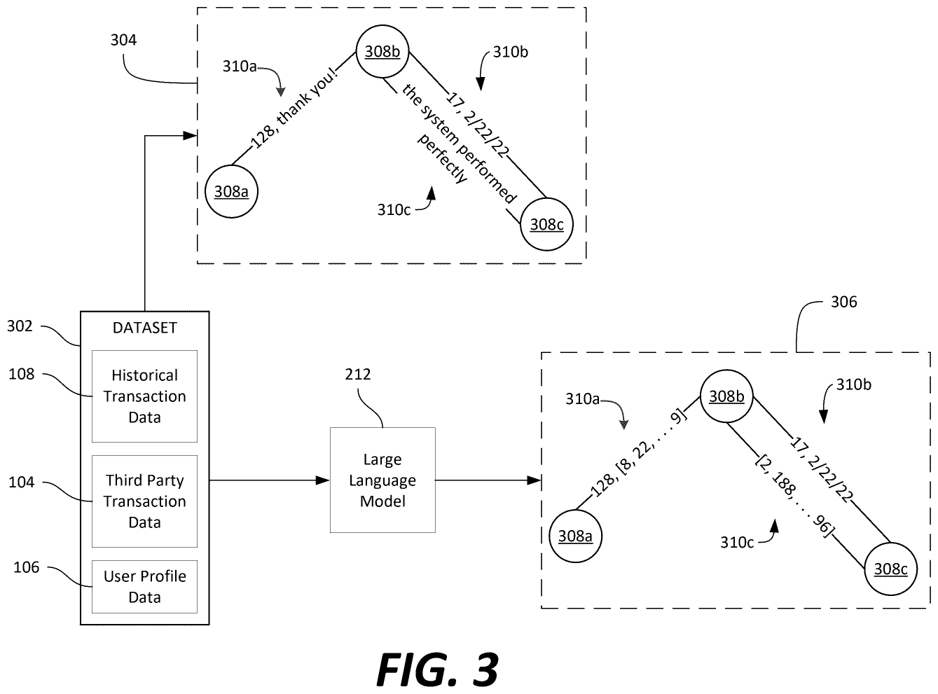

FIG. 3 is a diagram illustrating enhancement of a graph using a large language model applied to edge textual information of the graph. FIG. 3 illustrates the edge text encoding block 218 of FIG. 2 in greater detail.

As the edge text in a graph is originally derived from a dataset 302, which may include data from sources such as the historical transaction data 108, the third party transaction data 104, the user profile data 106, and/or other data sources, the encoding process may be considered as applying the LLM 212 to text data in the data set that is descriptive of relationships present in or determinable from the dataset 302. Accordingly, the dataset 302 may be used both as input to the LLM 212 as edge text and to build the nodes and edges of a graph.

FIG. 3 illustrates a graph portion that may be included into a larger graph (along with other graph portions). The graph portion is illustrated in a first state 304, with textual information along its edges, and a second state 306, in which the textual information has been encoded into embeddings vectors.

The example graph portion includes three nodes 308a, 308b, 308c and three edges 310a, 310b, 310c. The three nodes 308a, 308b, 308c may be representative of parties, and each edge 310a, 310b, 310c may be representative of an inter-party transaction. A first edge 310a connects the first node 308a to the second node 308b, and the second and third edges 310b, 310c connect the second node 308b to the third node 308c. Although each inter-party transaction may include similar associated information, in embodiments, different information types are illustrated along each edge in FIG. 3 for clarity of description.

The first edge 310a includes both numeric information (“128”) and textual information (“thank you!”) in the first state 304. In the second state 306, the numeric information remains in the graph, and the textual information has been encoded into a representative vector (“[8, 22, . . . , 9]”) that can be digested by a GNN model. The second edge 310b includes only numeric information (“17” and “Feb. 22, 2022”), and thus is identical in the first and second states 304, 306. The third edge 310c includes only textual information (“the system performed perfectly”), which is replaced by an encoded vector representation (“[2, 188, . . . , 96]”) in the second state 306. As described above, the numeric information may be a date or quantity or other value associated with the inter-party transaction, and the textual information may be, for example, a user note associated with the transaction.

Each node 308a, 308b, 308c may also be associated with numeric and textual information, and the textual information may similarly be encoded into vectors usable by a GNN model, with the numeric information remaining, between the first and second states 304, 306 of the graph.

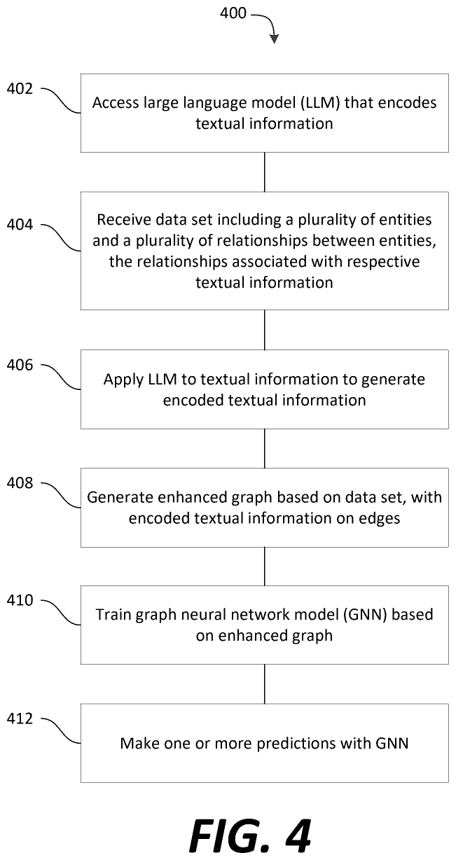

FIG. 4 is a flow chart illustrating an example method 400 of enhancing a graph to improve predictions by a graph neural network. The method 400, or one or more aspects of the method 400, may be performed by the risk classification system 102, and thus the method 400 may be computer-implemented.

The method 400 may include, at operation 402, accessing a large language model (LLM) that encodes textual information. Accessing the LLM may include interacting with a locally-stored LLM, or may include accessing a network-accessible LLM. The LLM may be maintained by the party performing operation 402, or may be maintained by a third party. The LLM may have been trained on a dataset specific to a domain for which the method 400 is performed, in some embodiments. The LLM may be configured to receive, as input, one or more sets of textual information and to output a respective embeddings vector or other numeric representation for each textual information set.

The method 400 may further include, at operation 404, receiving a data set that includes a plurality of entities and a plurality of relationships between the entities, where each relationship has associated textual information. The entities may be, for example, end users, enterprise users, computing systems, physical sites accessed by users via computing (e.g., electronically-secured access), and the like. Each relationship may be, for example, an inter-party transaction, an access by a user to a secured computing service or secured physical location, an inter-party social media connection, another connection between a user and a location (e.g., a place of residence, place of employment, etc.), and the like. The data set may include, for example, historical transaction data, third party transaction data, and/or user profile data, as described above with respect to FIG. 1.

Both the entities and the relationships included in the received data may include associated numeric information and/or textual information. Numeric information may include, for example, dates, quantities, directions, numeric aspects of addresses, numeric values associated with computing systems, ZIP codes, phone numbers, and the like. Textual information may include, for example, inter-party notes, names, descriptions of goods or services that were the subject of a transaction, textual aspects of addresses, and the like.

The method 400 may further include, at operation 406, applying the LLM to the textual information in the data set (e.g., providing the textual information as input to the LLM) to generate encoded textual information. The LLM may be applied to textual information associated with both entities and relationships, in some embodiments. In other embodiments, the LLM may be applied to textual information associated with only relationships.

The method 400 may further include, at operation 408, generating or otherwise determining an enhanced graph based on the data set, where the enhanced graph includes the enhanced textual information on the associated edges of the graph. The graph may be generated at operation 408 by generating a node for each entity in the data set, and an edge for each relationship. Accordingly, the graph may include one or more edges between each node in the graph, reflective of the quantity of relationships between any two given entities. Each node and each edge may include the associated numeric information. Each edge may include, instead of or in addition to the associated textual information, the encoded textual information generated at operation 406, thus yielding the enhanced graph. The graph may be “enhanced” relative to a graph lacking the encoded edge textual information.

In some embodiments, operation 408 may include determining the enhanced graph by supplementing an existing graph with the encoded textual information. That is, a version of the graph, lacking the encoded textual information, may exist prior to operation 408, and operation 408 may include adding the encoded textual information to the graph, either in addition to or in replacement of the non-encoded textual information.

The method 400 may further include, at operation 410, training a graph neural network model based on the enhanced graph. Training at operation 410 may include training the GNN model to make one or more classifications or predictions regarding or respective of one or more nodes or edges of an input graph, and/or to output one or more embeddings vectors respective of the nodes or edges of the graph. Such predictions or classifications may include, for example, a likelihood that a particular user node in the graph would perform an adverse computing action respective of a resource if given access to that resource. For example, the resource may be a shared computing resource, a secured facility, or a line of credit. The adverse computing action may be, for example, fraudulent activity, upload of malicious code to the shared computing resource, use of the shared computing resource outside of licensed terms, performance of illicit activity with the shared computing resource, theft from a secured facility, performance of illicit activity at the secured facility, or a default on a line of credit.

Training at operation 410 may include use of a set of training data that includes one or more graphs of domain-specific nodes and relationships. The training data may include the graph generated at operation 408, or a portion or subset thereof. The training data may include data respective of entities and relationships related to the same domain as the graph generated at operation 410.

Training at operation 410 may include training the GNN model to make multiple similar classifications and/or predictions for nodes and/or relationships. For example, the GNN may be trained to make a prediction of an adverse computing action for each of many entities for multiple time periods (e.g., a first predicted likelihood of an adverse computing action within 90 days, a second predicted likelihood of an adverse computing action within 300 days, etc.), predictions of multiple types of adverse computing actions respective of each entity, etc.

The method 400 may further include, at operation 412, making one or more predictions or classifications with the GNN. The predictions and classifications made at operation 412 may be of the types described above, and may be made with respect to the enhanced graph generated at operation 408.

The method 400 may be performed to make a plurality of classifications or predictions over time. Accordingly, as new entities or relationships are added to available data sets, such new entities or relationships may be input to the LLM to convert textual information to encoded textual information, one or more graphs may be updated, and the GNN model may be re-trained and/or re-applied to the updated graph to make further classifications or predictions. In some embodiments, the GNN model may be re-trained periodically (e.g., weekly, monthly, yearly) independent of its use. Further, in some embodiments, when new data points (entities or relationships) are added to available data sets, the GNN model may be applied periodically (e.g., daily, weekly) to make predictions and/or classifications for the new data points, and/or the GNN model may be applied on demand when such a classification or prediction is required. In some embodiments, when a new data point is introduced and a prediction respective of that data point is needed at the time of its introduction, a small graph may be constructed around that new data point (e.g., a two-hop graph or a three-hop graph), and the GNN model may be applied to the small graph for a substantially real-time prediction or classification and subsequent action based on that prediction or classification.

FIG. 5 is a flow chart illustrating an example method of iteratively training multiple machine learning models to improve predictions by a graph neural network. The method 500, or one or more aspects of the method 500, may be performed by the risk classification system 102.

The method 500 may include, at operation 502, training a graph neural network based on an enhanced graph. The training may be performed as described with respect to operation 410 above.

The method 500 may further include, at operation 504, training a large language model based on node predictions made by the trained GNN. For example, the LLM may be trained based on labels applied to GNN predictions, with the parameter and function weights of the LLM altered according to the accuracy of those predictions.

The method 500 may further include, at operation 506, re-applying the trained LLM (as altered at operation 504) to edge textual information and/or node textual information to generate an enhanced graph. The method 500 may then return to operation 502 to further train the GNN based on the enhanced graph, where the enhanced graph at each successive iteration of operation 502 is different from the enhanced graph at the previous iteration by virtue of the encoded textual information being different, as the LLM has been re-trained.

The method 500 may be performed for as many successive iterations as required for the LLM and GNN to reaches a desired accuracy, or until accuracy converges to a maximum.

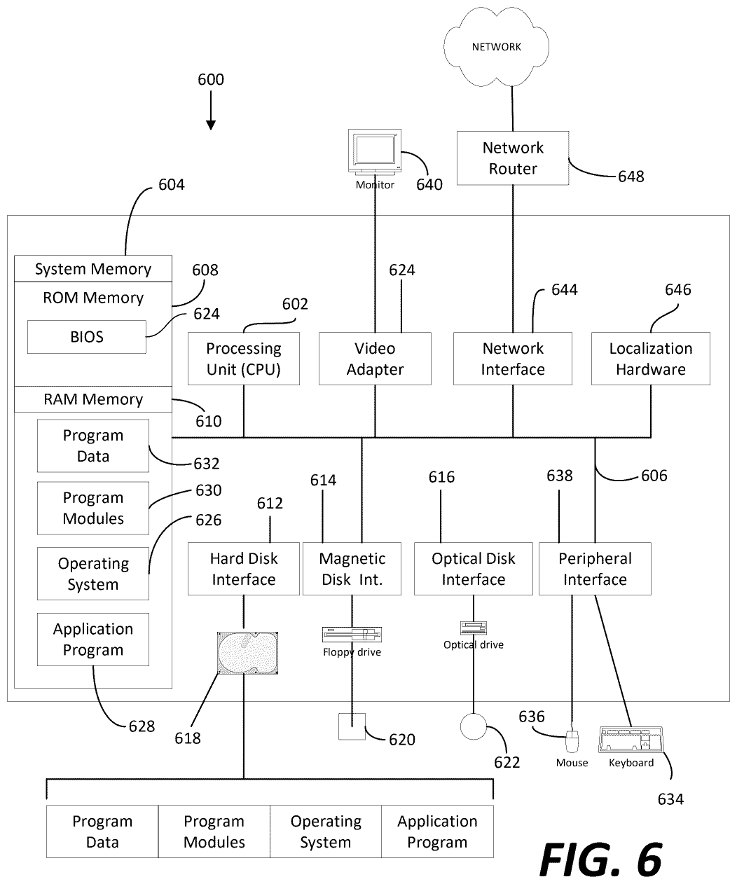

FIG. 6 is a block diagram of an example computing system, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 624. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 648, that is responsible for network routing. Communications with the network router 648 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600. Data from the localization hardware 646 may be included in a callback request or other user computing device metadata in the methods of this disclosure.

The computing system 600, or one or more portions thereof, may embody a user computing device 112, in some embodiments. Additionally or alternatively, some components of the computing system 600 may embody the risk classification system 102 and/or transaction processing system 110. For example, the functional modules 120, 122, 124 may be embodied as program modules 630.

In a first aspect of the present disclosure, a computer-implemented method is provided. The method includes accessing a large language model (LLM) configured to encode textual information to generate encoded textual information, receiving a data set comprising a plurality of entities and a plurality of relationships among the entities, each relationship associated with respective textual information, and determining a graph representative of the data set, the graph including a plurality of nodes and a plurality of edges connecting the nodes, each node representative of a respective entity of the plurality of entities and each edge representative of the relationship between the entities connected by the edge. The determining includes, for each edge, applying the LLM to the textual information associated with the relationship represented by the edge to generate encoded edge textual information and adding the encoded edge textual information to the edge in the graph, whereby an enhanced graph is generated. The method further includes training a graph neural network model (GNN) based on the enhanced graph.

In an embodiment of the first aspect, receiving the LLM includes training the LLM on a corpus of information specific to a domain represented by the graph.

In an embodiment of the first aspect, applying the LLM to the textual information associated with the relationship represented by the edge includes providing, as input to the LLM, the textual information associated with the relationship represented by the edge, and the textual information associated with one or more additional edges that connect the same nodes as the edge.

In an embodiment of the first aspect, applying the LLM to the textual information associated with the relationship represented by the edge includes providing, as input to the LLM, numerical information associated with the relationship represented by the edge.

In an embodiment of the first aspect, applying the LLM to the textual information of an edge includes providing, as input to the LLM, attributes of the nodes connected by the edge.

In an embodiment of the first aspect, the method further includes applying the trained GNN to generate a prediction regarding at least one of the entities.

In an embodiment of the first aspect, one or more entities are end users, and edges representative of relationships between end users comprise textual information comprise user-to-user notes; and/or one or more entities are end users and one or more entities are enterprise users, and edges representative of a relationships between an end user and an enterprise user comprise descriptions of resources conveyed from the enterprise user to the end user.

In an embodiment of the first aspect, training the GNN includes training the GNN to make a respective predictive classification for each node. In a further embodiment of the first aspect, the graph is a first graph, and the method further includes determining a second graph representative of the data set, the second graph including the plurality of nodes and the plurality of edges connecting the nodes, wherein determining the second graph includes, for each edge of the second graph, applying the LLM to the textual information associated with the relationship represented by the edge, and to the predictive classifications of the GNN for the nodes connected by the edge, to generate second encoded edge textual information, whereby a second enhanced graph is generated, and further training the GNN based on the second enhanced graph.

In a second aspect of the present disclosure, a computing system is provided that includes a processor and a non-transitory, computer-readable medium storing instructions that, when executed by the processor, cause the computing system to perform operations that include accessing a large language model (LLM) configured to encode textual information to generate encoded textual information, generating a graph comprising a plurality of nodes and a plurality of edges connecting the nodes, each node representative of a respective entity and each edge representative of a computing action involving the entities connected by the edge, each computing action associated with respective textual information, wherein the generating comprises applying the LLM to the textual information associated with each edge to generate encoded edge textual information and adding the encoded edge textual information to the graph, training a graph neural network model (GNN) based on the graph, and outputting a prediction about one of the entities according to the trained GNN.

In an embodiment of the second aspect, the prediction includes a probability of a fraudulent transaction by the one of the entities.

In an embodiment of the second aspect, applying the LLM to the textual information associated with each edge includes, for each edge, providing, as input to the LLM, two or more of the textual information associated with one or more additional edges that connect the same nodes as the edge, numerical information associated with the computing action represented by the edge, or attributes of the nodes connected by the edge. In a further embodiment of the second aspect, applying the LLM to the textual information associated with each edge includes, for each edge, providing, as input to the LLM, the textual information associated with one or more additional edges that connect the same nodes as the edge, numerical information associated with the computing action represented by the edge, and attributes of the nodes connected by the edge.

In an embodiment of the second aspect, generating the graph further includes applying the LLM to the textual information associated with each node to generate encoded node textual information and adding the encoded node textual information to the graph.

In an embodiment of the second aspect, the operations further include training the LLM using a training data set including computing actions involving a subset of the entities represented in the graph.

In an embodiment of the second aspect, the operations further include repeatedly, for each edge, applying the LLM to the textual information associated with the computing action represented by the edge, and to respective predictive classifications of the trained GNN for the nodes connected by the edge, to generate second encoded edge textual information and adding the second encoded edge textual information to the edge in the graph, whereby a further enhanced graph is generated, further training the GNN based on the further enhanced graph, and re-training the LLM according to predictions made by the further trained GNN.

In a third aspect of the present disclosure, a computer-implemented method is provided that includes accessing a large language model (LLM) configured to encode textual information to generate encoded textual information, accessing a graph comprising a plurality of nodes and a plurality of edges connecting the nodes, each node representative of a respective entity and each edge representative of a relationship between the entities connected by the edge, each edge associated with respective textual information, applying the LLM to the textual information associated with each edge to generate encoded edge textual information and adding the encoded edge textual information to the graph to yield an enhanced graph, training a graph neural network model (GNN) based on the enhanced graph, training the LLM according to node predictions made by the trained GNN, re-applying the trained LLM to the textual information associated with each edge to generate further encoded edge textual information to yield a further enhanced graph, and further training the GNN based on the further enhanced graph.

In an embodiment of the third aspect, the method further includes repeating the training the LLM, re-applying the trained LLM, and further training the GNN, and deploying the trained GNN after the repeating.

In an embodiment of the third aspect, the method further includes receiving a request from a user represented in the graph to perform a computing action, determining a fraud risk of the computing action according to the trained GNN, and generating a response to the user according to the fraud risk.

In an embodiment of the third aspect, applying the LLM to the textual information of an edge includes providing, as input to the LLM, attributes of the nodes connected by the edge.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

1. A computer-implemented method comprising:
accessing a large language model (LLM) configured to encode textual information to generate encoded textual information, the encoded textual information comprising a vector representation of the textual information;
receiving a data set comprising a plurality of entities and a plurality of relationships among the entities, each relationship associated with respective textual information;
determining a graph representative of the data set, the graph comprising a plurality of nodes and a plurality of edges connecting the nodes, each node representative of a respective entity of the plurality of entities and each edge representative of the relationship between the entities connected by the edge, wherein the determining comprises:
for each edge, applying the LLM to the textual information associated with the relationship represented by the edge to generate encoded edge textual information comprising a vector representation of the textual information associated with the relationship and adding the encoded edge textual information to the edge in the graph, whereby an enhanced graph is generated; and
training a graph neural network model (GNN) based on the enhanced graph.

2. The computer-implemented method of claim 1, wherein receiving the LLM comprises training the LLM on a corpus of information specific to a domain represented by the graph.

3. The computer-implemented method of claim 1, wherein applying the LLM to the textual information associated with the relationship represented by the edge comprises providing, as input to the LLM:
the textual information associated with the relationship represented by the edge; and
the textual information associated with one or more additional edges that connect the same nodes as the edge.

4. The computer-implemented method of claim 1, wherein applying the LLM to the textual information associated with the relationship represented by the edge comprises providing, as input to the LLM:
numerical information associated with the relationship represented by the edge.

5. The computer-implemented method of claim 1, wherein applying the LLM to the textual information of an edge comprises providing, as input to the LLM:
attributes of the nodes connected by the edge.

6. The computer-implemented method of claim 1, further comprising applying the trained GNN to generate a prediction regarding at least one of the entities.

7. The computer-implemented method of claim 1, wherein one or more of:
one or more entities are end users, and edges representative of relationships between end users comprise textual information comprise user-to-user notes; or
one or more entities are end users and one or more entities are enterprise users, and edges representative of a relationships between an end user and an enterprise user comprise descriptions of resources conveyed from the enterprise user to the end user.

8. The computer-implemented method of claim 1, wherein training the GNN comprises training the GNN to make a respective predictive classification for each node.

9. The computer-implemented method of claim 8, wherein the graph is a first graph, the method further comprising:
determining a second graph representative of the data set, the second graph comprising the plurality of nodes and the plurality of edges connecting the nodes, wherein determining the second graph comprises:
for each edge of the second graph, applying the LLM to the textual information associated with the relationship represented by the edge, and to the predictive classifications of the GNN for the nodes connected by the edge, to generate second encoded edge textual information, whereby a second enhanced graph is generated; and
further training the GNN based on the second enhanced graph.

10. A computing system comprising:
a processor; and
a non-transitory, computer-readable medium storing instructions that, when executed by the processor, cause the computing system to perform operations comprising:
accessing a large language model (LLM) configured to encode textual information to generate encoded textual information, the encoded textual information comprising a vector representation of the textual information;
generating a graph comprising a plurality of nodes and a plurality of edges connecting the nodes, each node representative of a respective entity and each edge representative of a computing action involving the entities connected by the edge, each computing action associated with respective textual information, wherein the generating comprises applying the LLM to the textual information associated with each edge to generate encoded edge textual information, the encoded edge textual information comprising a vector representation of the textual information, and adding the encoded edge textual information to the graph;
training a graph neural network model (GNN) based on the graph; and
outputting a prediction about one of the entities according to the trained GNN.

11. The computing system of claim 10, wherein the prediction comprises a probability of a fraudulent transaction by the one of the entities.

12. The computing system of claim 10, wherein applying the LLM to the textual information associated with each edge comprises, for each edge, providing, as input to the LLM, two or more of:
the textual information associated with one or more additional edges that connect the same nodes as the edge;
numerical information associated with the computing action represented by the edge; or
attributes of the nodes connected by the edge.

13. The computing system of claim 12, wherein applying the LLM to the textual information associated with each edge comprises, for each edge, providing, as input to the LLM:
the textual information associated with one or more additional edges that connect the same nodes as the edge;
numerical information associated with the computing action represented by the edge; and
attributes of the nodes connected by the edge.

14. The computing system of claim 10, wherein generating the graph further comprises applying the LLM to the textual information associated with each node to generate encoded node textual information and adding the encoded node textual information to the graph.

15. The computing system of claim 10, further comprising training the LLM using a training data set comprising computing actions involving a subset of the entities represented in the graph.

16. The computing system of claim 10, wherein the operations further comprise repeatedly:
for each edge, applying the LLM to the textual information associated with the computing action represented by the edge, and to respective predictive classifications of the trained GNN for the nodes connected by the edge, to generate second encoded edge textual information and adding the second encoded edge textual information to the edge in the graph, whereby a further enhanced graph is generated;
further training the GNN based on the further enhanced graph; and
re-training the LLM according to predictions made by the further trained GNN.

17. A computer-implemented method comprising:
accessing a large language model (LLM) configured to encode textual information to generate encoded textual information, the encoded textual information comprising a vector representation of the textual information;
accessing a graph comprising a plurality of nodes and a plurality of edges connecting the nodes, each node representative of a respective entity and each edge representative of a relationship between the entities connected by the edge, each edge associated with respective textual information;
applying the LLM to the textual information associated with each edge to generate encoded edge textual information, the encoded edge textual information comprising a vector representation of the textual information associated with the edge, and adding the encoded edge textual information to the graph to yield an enhanced graph;
training a graph neural network model (GNN) based on the enhanced graph;
training the LLM according to node predictions made by the trained GNN;
re-applying the trained LLM to the textual information associated with each edge to generate further encoded edge textual information to yield a further enhanced graph; and
further training the GNN based on the further enhanced graph.

18. The computer-implemented method of claim 17, further comprising:
repeating the training the LLM, re-applying the trained LLM, and further training the GNN; and
deploying the trained GNN after the repeating.

19. The computer-implemented method of claim 17, further comprising:
receiving a request from a user represented in the graph to perform a computing action;
determining a fraud risk of the computing action according to the trained GNN; and
generating a response to the user according to the fraud risk.

20. The computer-implemented method of claim 17, wherein applying the LLM to the textual information of an edge comprises providing, as input to the LLM:
attributes of the nodes connected by the edge.
